(19) United States
(12) Patent Application Publication
(10) Pub. No.: US 2026/0030014 A1
(43) Pub. Date: Jan. 29, 2026

(54) SOFTWARE UPDATE IN SMART HOUSEHOLD APPLIANCES

(71) Applicant: ELECTROLUX APPLIANCES AKTIEBOLAG, Stockholm (SE)

(72) Inventor: Livio PLOS, Porcia (IT)

(73) Assignee: ELECTROLUX APPLIANCES AKTIEBOLAG, Stockholm (SE)

(21) Appl. No.: 18/994,713

(22) PCT Filed: Jul. 15, 2022
(86) PCT No.: PCT/EP2022/069853

§ 371 Date: Jan. 15, 2025

(51) Int. Cl. G06F 8/65; H04L 12/28; H04W 4/30

(52) U.S. Cl. CPC G06F 8/65; H04L 12/2814; H04W 4/30; H04L 2012/285

(57) ABSTRACT

A household appliance including a processing unit configured to store and execute a software that is subject to updates, a software updater configured to deliver to the processing unit a software package for a software update, and a broadcast device, preferably a BLE beacon device, configured to wirelessly broadcast a signal that can be received by a mobile device. The software updater is further configured to monitor the progress of the software update and to cause the broadcast device to broadcast a signal containing information related to the progress.

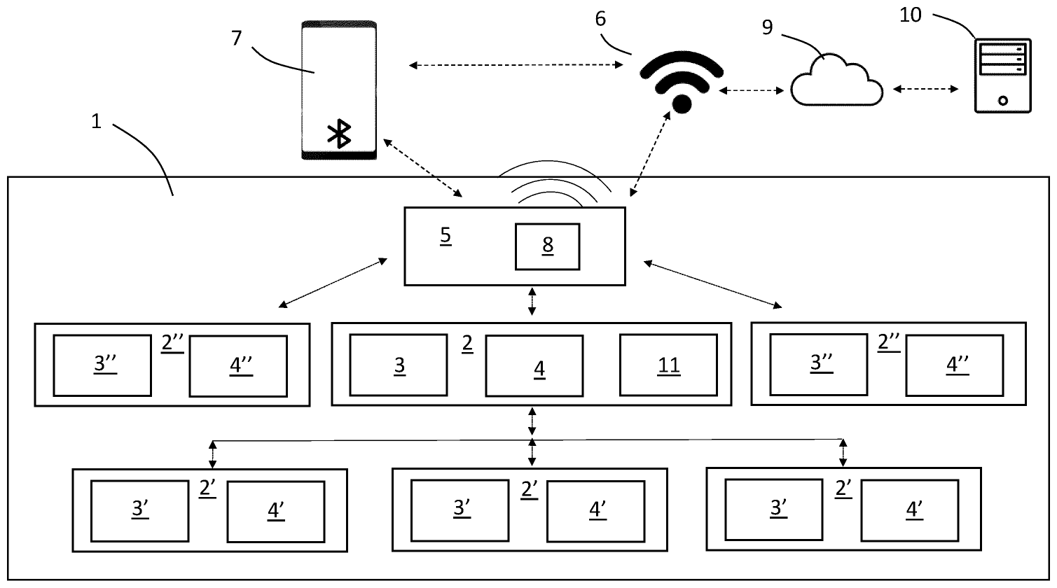

The present invention relates in general to the technical field of household appliances, e.g., washing machines, dishwashers, ovens, etc., in particular to smart electrical household appliances, also known as network-connectable or Internet-of-Things (IoT) electrical household appliances, i.e., electrical household or domestic appliances with connection interfaces designed to allow the smart household appliances to connect in a wired or wireless manner to a network or mobile devices, such as smartphones or tablets.

In particular, the present invention relates to the update/upgrade of software in household appliances and to how to inform users of the household appliances about progresses in the software updating/upgrading operations.

### STATE OF THE ART

As is known, household appliances are getting everyday more and more connected to the Internet to deliver new services to the customers. An added value brought to the customers by the Internet connectivity is the ability to keep the household appliance software updated/upgraded to the latest version available.

For the purposes of the present invention, the term “software” is intended to generically cover both software and firmware aspects. Moreover, the term “update” in relation to a software is intended to generically cover both enhancement to a current version of the software (generally referred to as software update) and replacement of the current version of the software with a new one (generally referred to as software upgrade). Therefore, when talking about an update of a software of the appliance, reference is made to an update and/or an upgrade of a software and/or a firmware of the appliance.

Moreover, with household appliance it is here intended an appliance designed for use in domestic environment, typically to assist in household functions such as cooking, cleaning, laundry washing and food preservation. Examples of household appliances are washing machines, dryers, washer-dryers, dishwashers, refrigerators, freezers, ovens, hobs, hoods, vacuum cleaners, air conditioners, air purifiers and water heaters.

Most of the smart household appliances nowadays on the market are designed to automatically start a configuration process comprising checking for software updates. When a software update adding new features or fixing bugs is notified to be available and is validated, it is automatically deployed or proposed to users for a deployment. Such deployment can be done over the air to the smart household appliances, where it is downloaded, installed and executed.

### OBJECT AND SUMMARY OF THE INVENTION

To the Applicant's best knowledge, in the smart household appliances nowadays on the market, the customers become aware that software updating has completed by the household appliance being restarted and becoming operational again.

Software updating requires a certain number of steps to be performed and takes some time to be completed, typically of the order of minutes, so the software updating proceeds completely blindly for users, who are not aware of the progress of it.

Besides, the software updating is particularly critical from security and safety point of views because during the software updating the smart household appliances may be vulnerable to external attacks, as well as being non-operative or not fully functional.

The Applicant has understood that the monitoring of the various steps of the software updating and the real-time notification or signalling of the progress of such updating to the users, possibly together with information on when the full functioning of the household appliance will be available again, would represent an important added value to users.

The Applicant has also understood that a further added value would be keeping the household appliances secure during software updating, without the need to depend on an external resource to prevent it from being distracted or harmed by any external entity, to reduce to the minimum the risk of failure of the software updating or of remaining in the middle thereof.

The present invention is therefore related to a technique for real-time monitoring the progress of software updating in a household appliance and for advertising customers and users via a human-machine interface of the same household appliance and/or remotely via a dedicated software application running on personal smart devices or on other home devices, while keeping the household appliance secure during the software updating, without the need to depend on an external resource to prevent it from being distracted or harmed by any external entity.

The Applicant has found that broadcasting information related to the status of the software update by means of the same household appliance is a particularly efficient way to real-time informing users about such status. In particular, the Applicant has found that Bluetooth beaconing is a suitable technique for such broadcasting.

According to a first aspect thereof, the present invention is thus related to a smart household appliance comprising at least one processing unit, or electronic device, designed to load a software and to receive updates of such software, and a communication interface designed to broadcast an information related to the status of the software update.

More in detail, the present invention is related to a household appliance comprising at least a processing unit configured to store and execute a software that is subject to updates and a software updater configured to deliver to the processing unit at least a software package for a software update, wherein the appliance further comprises a broadcast device configured to wirelessly broadcast a signal that can be received by a mobile device and wherein the software updater is further configured to monitor the progress of the software update and to cause said broadcast device to broadcast a signal containing information related to said progress.

The software update is preferably made by means of an over-the-air (OTA) technique.

Preferably, the broadcast device comprises a beacon device. More preferably, the broadcast device comprises a BLE beacon device. The broadcasting is therefore preferably implemented by Bluetooth beaconing. However, the broadcasting could be implemented also by other signal broadcasting technique.

The household appliance preferably comprises an electronic communication interface configured to establish a wireless bi-directional communication connection with a wireless network and/or mobile devices, and further configured to communicate with the software updater. In particular, the electronic communication interface is preferably configured to establish a Wi-Fi bi-directional communication connection with the wireless network and a Bluetooth connection with the mobile device(s).

Preferably, the electronic communication interface comprises said broadcast device. In particular, the electronic communication interface is preferably configured to be operable as a beacon device to advertise in a wireless way said information.

Said information is preferably suitable to be presented to a user via an output device of the mobile device.

The household appliance advantageously comprises a control unit to control operation of the household appliance. The software updater may be included in the control unit.

In one possible embodiment, the control unit is configured to cause the progress of the update of the control software to be displayed on an electronic display of the household appliance.

The software updater is preferably configured to:
check, through a wireless network, the availability of a software update; and
receive, through the wireless network or a mobile device, software update notifications indicative of the availability of a software update.

Moreover, the software updater is preferably further configured to:
download, through the wireless network or a mobile device, the software update;
validate and install the downloaded software update.

The software updater may be configured also to restart one or more operations of the household appliance when the software update is completed.

According to a second aspect thereof, the present invention is related to an updatable software loadable in and executable by a processing unit of the previously described household appliance.

According to a third aspect thereof, the present invention is related to a method for managing, or implementing, a software update in a household appliance, comprising the steps of monitoring the progress of the software update and broadcasting a signal containing information related to said progress.

Preferably, the broadcasting is made by Bluetooth beaconing. The broadcasted signal is suitable to be received by a mobile device.

The software update is made in at least one processing unit of the household appliance and the method comprises the step of delivering to the processing unit at least a software package.

Preferably, the method further includes the step of establishing a connection with a wireless network in order to receive the software package. Moreover, the method preferably includes the steps of checking, through the wireless network, the availability of a software update, and receiving, through the wireless network or a mobile device, software update notifications indicative of the availability of a software update.

The method preferably further includes the steps of validating and installing the software update. The method may also include the step of restarting one or more operations of the household appliance when the software update is completed.

The method preferably includes also the step of presenting said information related to said progress, or a related information, to a user via an output device of the mobile device.

The method may also include the step of presenting said information related to said progress, or a related information, to a user on a user interface of the household appliance.

### BRIEF DESCRIPTION OF THE DRAWINGS

The accompanying FIGURE schematically shows block diagrams of a system for advertising the progress of a software updating in a smart household appliance according to the present invention.

### DETAILED DESCRIPTION OF PREFERRED EMBODIMENTS OF THE INVENTION

The present invention will now be described in detail with reference to the accompanying FIGURE in order to allow a skilled person to implement it and use it. Various modifications to the described embodiments will be readily apparent to those of skill in the art and the general principles described may be applied to other embodiments and applications without however departing from the protective scope of the present invention as defined in the appended claims. Therefore, the present invention should not be regarded as limited to the embodiments described and illustrated herein and should be allowed the broadest protection scope consistent with the features described and claimed herein.

Unless otherwise defined, all technical and scientific terms used herein have the same meaning commonly understood by one of ordinary skill in the art to which the invention belongs. In case of conflict, the present specification, including the definitions provided, should prevail. Furthermore, the examples are provided for illustrative purposes only and as such should not be considered limiting.

In a nutshell, the idea underlying the present invention is to exploit a peculiar functionality of wireless communication interfaces to advertise the progress of software updating in a smart household appliance in a connectionless way, namely without requiring a connection between the smart household appliance and external devices for keeping users updated on the progress of the software updating. According to a preferred embodiment, the present invention relates to an OTA (Over-The-Air) software updating.

According to a preferred embodiment, the peculiar functionality is the Bluetooth advertising functionality available in a particular type of Bluetooth interfaces/devices, which is a permission-based mobile marketing/advertising functionality focused at reaching customers on their Bluetooth-enabled mobile devices through mobile applications. This is typically done to advertise a content, for example special offers in a store, or to allow nearby mobile devices to determine their physical locations, customers to be tracked, or location-based actions to be triggered on the mobile devices, such as a check-in on social media or a push notification.

The advertised content is received by nearby Bluetooth-enabled mobile devices, such as smartphones, tablets, laptops or personal device assistants (PDAs), and appropriately delivered/presented to users via output devices of the mobile devices, typically displays.

In particular, said Bluetooth interfaces/devices comprise so-called Bluetooth beacons, a class of Bluetooth Low Energy (BLE) messages that may be communicated as BLE beaconing packets according to different beacon standards. These standards include, but are not limited to, iBeacon by Apple, AltBeacon, URIBeacon, etc. Each standard has its own protocol specification that defines the message format for proximity beacon advertisements. Preferably the BLE beaconing packets are electronic beaconing packets, i.e. e-beaconing packets.

Beaconing does not accept any interaction from external electronic devices and acts as a radio lighthouse that is sending dynamic information instead of keeping on broadcasting always the same one.

The accompanying FIGURE schematically shows a smart household appliance 1 designed to operate in a broadcasting mode to advertise the progress of software updating. With broadcasting it is here intended a wireless unidirectional signal transmission.

Preferably the household appliance 1 is configured to perform an OTA software update. However, it is understood that the present invention is not limited to OTA software updating, but it may envisage other procedures for performing software updates in the household appliance 1. For example, the household appliance 1 may be configured to perform the software updates by means of a USB connection system, i.e. by connecting a USB port/connector of the household appliance 1 (i.e. arranged on the control panel) to a removable USB memory device containing the software updates.

The household appliance 1 comprises an electronic control unit 2 having loaded therein a control software to control operation of the household appliance 1.

More precisely, the household appliance 1 comprises an electronic control unit 2 configured to store and execute a control software designed to cause, when executed, the control unit 2 to become configured to control operation of the household appliance 1 according to the stored control software.

To this purpose, the control unit 2 comprises memory resources 3 designed to store the control software and electronic processing resources 4 designed to read from the memory resources 3 and execute the control software.

According to a preferred embodiment, the household appliance 1 further comprises an electronic communication interface 5. The communication interface 5 is preferably designed to establish a wireless bi-directional communication connection with a local network 6 and/or with mobile devices 7, such as smartphones or tablets. The mobile devices 7 preferably communicate with the household appliance 1 via WI-FI or cellular data technologies.

The local network 6 may be based on any available wired or wireless computer network technologies, in particular a (wired) local area network (LAN) technology, such as Ethernet technology, or a wireless local area network (WLAN) technology. Preferably, network 6 is a Wi-Fi network, to which the following description will refer without any loss of generality.

Through the local network 6, the appliance 1 can access a global network 9 (typically, the internet network) and a remote server 10 connected to the global network 9. The local network 6 and the global network 9 form together a communication network which allows communication between the appliance 1 and the remote server 10.

To establish a wireless bi-directional communication connection with the network 6 and the mobile devices 7, the household appliance 1 is preferably both Wi-Fi-enabled and Bluetooth-enabled. In particular, the communication interface 5 is suitable to establish a Wi-Fi bi-directional communication connection with the network 6 and a Bluetooth connection with the mobile devices 7.

The communication interface 5 is in communication with the control unit 2. In particular, according to a preferred embodiment of the present invention, the communication interface 5 is electrically connected to the control unit 2. It is however understood that, in alternative or in addition, the communication interface 5 may be wirelessly connected to the control unit 2.

Moreover, the communication interface 5 is designed to establish a wired bi-directional communications connection with the network 6 and/or with the mobile devices 7.

The household appliance 1 further comprises a broadcasting device 8 configured to wirelessly broadcast a signal suitable to be received by a nearby mobile device 7.

With “nearby” it is here intended a distance not higher than the coverage distance of the considered broadcasting device 8. For example, this coverage distance can be of the order of one hundred meters in case of Wi-Fi and of the order of ten meters in case of BLE.

Advantageously, the broadcasted signal is an advertising signal containing an information that can be presented to a user via an output device of a mobile device 7.

The broadcasting device 8 may be the same communication interface 5 or part of it. In particular, the broadcasting device 8 may be a wireless network interface controller (WNIC) comprised in the communication interface 5.

The WNIC is designed to allow the communication interface 5 to establish wireless bi-directional communication connection, for example a Wi-Fi connection with network 6 and/or a Bluetooth connection with Bluetooth-enabled mobile devices 7.

Preferably, the broadcasting device 8 is a beacon device, or comprises a beacon device. More preferably, the broadcasting device 8 is a BLE beacon device, or comprises a BLE beacon device. More in detail, the broadcasting device 8 is preferably compliant with the Bluetooth technology according to at least the specification 4.0, also known as Bluetooth Low Energy (BLE) or Bluetooth Smart, which provides for the so called “beacon” functionality, designed for wirelessly broadcasting signals and related information. Accordingly, the communication interface 5 can operate as a BLE beacon device (or interface), i.e., it can broadcast an advertising (or broadcasting) signal containing an advertising content intended to be received by a Bluetooth-enabled mobile device 7 (i.e., a mobile device 7 having a Bluetooth receiving device) and appropriately notified to the user of the mobile device 7, typically displayed on an electronic display thereof. In other words, the BLE beacon device is configured to send information containing beacon advertising content.

When the Bluetooth receiving device of a nearby mobile device 7 (i.e., a mobile device 7 positioned within the communication range of the broadcasting device 8) receives the broadcasted signal, the mobile device 7 can download the advertising content and notify or display related information to the user.

The software loaded in the control unit 2 is subject to updates. For this purpose, the control unit 2 is preferably designed to store and execute a software updater 11, namely a software program designed to cause, when executed, the control unit 2 to become configured for the update of the control software.

The software updater 11 is preferably designed to cause, when executed, the control unit 2 to become configured to check, through the network 6, availability of software updates, either automatically or in response to a user input, and to receive, through the network 6 or a mobile device 7, software update notifications indicative of availability of software updates.

Moreover, software updater 11 is preferably designed to cause, when executed, the control unit 2 to become configured to download, through the network 6 or a mobile device 7, software updates, and to validate and install the downloaded software updates.

The software updater 11 may also be designed to cause, when executed, the control unit 2 to become configured to restart operation of the household appliance 1 when the software updating is completed.

To check the availability of software updates, a query may be sent to the remote server 10 via the communication interface 5 and the networks 6 and 9. The query may contain identification information about the appliance and the current version of the overall software of the appliance.

Based on this information, the server can check if a new version of the software is available. When a new version is available, it can be sent to, and received by, the appliance 1 via the networks 6 and 9 and the communication interface 5.

The software updater 11 is preferably further designed to cause, when executed, the control unit 2 to become configured to monitor the progress of software updating and cause the progress of software updating to be advertised in a connectionless way via the broadcasting device 8.

In one possible embodiment, the software updater 11 is designed to cause, when executed, the control unit 2 to become configured to cause the progress of software updating to be displayed on an electronic display of the household appliance 1, when available.

As an alternative or in addition to that, the software updater 11 is also designed to cause, when executed, the control unit 2 to become configured to cause the communication interface 5 to operate as a broadcasting device, in particular as a BLE beaconing device, to broadcast a signal containing information related to said progress. In other words, the progress of the software updating is advertised by the transmission of advertising data packets containing the information on the progress of software updating.

The advertised progress of the software updating may thence be received by nearby Bluetooth-enabled mobile devices 7 and related information can be appropriately delivered/presented to users via output devices of the mobile devices 7, e.g., graphically displayed (for example as a progress bar) on electronic displays of the mobile devices 7.

This related information can indicate, for example, the last executed phase in the software update, or the current percentage of the overall updating process. The related information can be also an error code in case there have been any problems during the software update procedure.

This same technique for software updating can be applied as well to other electronic parts of the appliance 1, as explained in the following.

Typically, as shown in accompanying FIGURE, the appliance 1 comprises, in addition to the control unit 2, a first group of processing units 2′ connected to the control unit 2 and designed to control a first group of electrically controllable components of the appliance 1. The processing units 2′ of this first group are not directly connected to the communication interface 5 and communicate with the communication interface 5 via the control unit 2. Preferably, all the processing units 2′ of the first group are connected with each other, for example via a bus system. In an alternative embodiment, only some of them are connected to a same bus.

Moreover, the appliance 1 may comprise, in addition or in alternative to the first group of processing units 2′, a second group of processing units 2″ directly connected to the communication interface 5, designed to control a second group of electrically controllable components of the appliance 1. The processing units 2″ of the second group may also be connected to the control unit 2.

Each processing unit 2′, 2″ may comprise one or more processors or microprocessors and/or one or more controllers or microcontrollers. Moreover, each processing unit 2′, 2″ preferably has one or more updatable software loaded therein, like the control unit 2.

The processing unit 2′, 2″ are preferably arranged on respective Printed Circuit Board (PCB), and each of them identifies, together with the respective PCB, a corresponding functional module of the appliance 1. Each PCB can contain one or more processing unit 2′, 2″.

The electrically controllable components may be arranged on the same PCB of the corresponding processing units 2′, 2″, or be arranged in separate parts of the appliance 1.

Each electrically controllable component may comprise electric, electronic, electromechanical and/or electrohydraulic components. For example, the electrically controllable component may be a user interface (and the corresponding functional module may be a user interface module) or a graphic display unit (and the corresponding functional module may be a display module).

Depending on the type of appliance, the electrically controllable component may be different types of components. For example, in case of a laundry machine, it can be an electronic switch for hydraulic valve opening/closing (and the corresponding functional module may be a switch module) or a heating resistor for washing liquid heating (and the corresponding functional module may be a heating module). In case of an oven, it can be a heating resistor for cooking cavity heating (and the corresponding functional module may be a heating module) or a TRIAC for controlling an oven fan (and the corresponding functional module may be a TRIAC module). In case of a refrigerator, it can be a TRIAC for controlling a refrigerator compressor (and the corresponding functional module may be a TRIAC module) or a further TRIAC for controlling a refrigerator fan (and the corresponding functional module may be a further TRIAC module).

Similarly to the control unit 2, also the processing units 2′, 2″ preferably comprise respective memory resources 3′, 3″ designed to store the respective (updatable) software and respective electronic processing resources 4′, 4″ designed to read from the memory resources 3′, 3″ and execute the software loaded therein.

For the purposes of the present invention, the same control unit 2 can be considered as a processing unit where an updatable software is loaded.

Moreover, still for the purposes of the present invention, the same communication interface 5 can be considered as a processing unit where an updatable software is loaded.

In a possible alternative embodiment (not illustrated), the software updater may be included (i.e., loaded) in the communication interface 5 instead of the control unit 2. In such a case, the software updater will preferably perform the same operations described above but in relation to the communication interface 5 instead of the control unit 2.

In particular, in this case it is the same communication interface 5 who performs the steps of:
checking, through the network 6, availability of software updates, either automatically or in response to a user input;
receiving, through the network 6 or a mobile device 7, software update notifications indicative of availability of software updates;
downloading, through the network 6 or a mobile device 7, software updates;
validating and installing the downloaded software updates; and
restarting operation of the household appliance 1 when the software updating is completed.

Moreover, in this case it is the communication interface 5 to monitor the progress of software updating and cause the progress of software updating to be advertised in a connectionless way via the broadcasting device 8.

In a further alternative embodiment (not illustrated), the broadcasting device 8 may be separate from the communication interface 5 and, in particular, be positioned on a different Printed Circuit Board (PCB). Also in this case, the broadcasting device 8 is preferably configured to perform the beacon functionality, i.e. it is preferably a beacon device, more preferably a BLE beacon device.

Moreover, also in this case, the broadcasting device 8 preferably communicates with the processing unit that includes the software updater (either the control unit 2 or the communication interface 5) in order to receive information related to the progress of the software update and to then broadcast a signal containing such information or related information. Again, this signal is suitable to be received by a mobile device 7.

Those skilled in the art may appreciate that information on the progress of software updating may be broadcasted using other present or future wired or wireless communication interfaces. For example, broadcasting of the signal related to the software update could be implemented by means of a properly modulated optical emitting device, for example a LED light emitter, or by means of a properly modulated sound emitter.

1. A household appliance comprising:
a processing unit configured to store and execute a software that is subject to updates; and
a software updater configured to deliver to the processing unit a software package for a software update;
a broadcast device configured to wirelessly broadcast signals that can be received by a mobile device; and
wherein the software updater is configured to monitor progress of the software update and to cause said broadcast device to broadcast a signal containing information related to said progress.

2. The household appliance according claim 1, wherein said broadcast device comprises a beacon device.

3. The household appliance according to claim 1, wherein said broadcast device comprises a BLE beacon device.

4. The household appliance according to claim 1, comprising an electronic communication interface configured to (i) establish a wireless bi-directional communication connection with at least one of a wireless network and the mobile device, and (ii) communicate with the software updater.

5. The household appliance according to claim 4, wherein the electronic communication interface is configured to establish a Wi-Fi bi-directional communication connection with the wireless network and a Bluetooth connection with the mobile device (7).

6. The household appliance according to claim 4, wherein said electronic communication interface comprises said broadcast device.

7. The household appliance according to claim 4, wherein said electronic communication interface is configured to be operable as a beacon device to advertise in a wireless way said information.

8. The household appliance according to claim 1, wherein said information is to be presented to a user via an output device of the mobile device.

9. The household appliance according to claim 1, comprising a control unit to control operation of the household appliance, wherein the software updater is included in the control unit.

10. The household appliance according to claim 9, wherein the control unit is configured to cause the progress of the update of the software to be displayed on an electronic display of the household appliance.

11. The household appliance according to claim 1, wherein the software update is performed using an over-the-air (OTA) technique.

12. The household appliance according to claim 1, wherein the software updater is configured to:
check, through a wireless network, availability of the software update;
receive, through the wireless network or the mobile device, a software update notification indicative of the availability of the software update; and
download, through the wireless network or the mobile device, the software update.

13. The household appliance according to claim 12, wherein the software updater is configured to:
validate and install the downloaded software update; and
restart operation of the household appliance when the software updating is completed.

14. A control unit comprising a processing unit of a household appliance and memory resources comprising software executable by the processing unit, wherein the software is configured to cause, when executed, the processing unit to:
receive a software package for a software update;
monitor progress of the software update; and
cause a broadcast device to broadcast a signal containing information related to the progress, wherein the household appliance comprises the broadcast device, and wherein the broadcast device is configured to wirelessly broadcast signals that can be received by a mobile device.

15. A method for managing a software update in a household appliance, comprising:
monitoring progress of the software update; and
generating a wireless broadcasting signal containing information related to said progress.
